(19) United States
(12) Patent Application Publication
(10) Pub. No.: US 2026/0162661 A1
(43) Pub. Date: Jun. 11, 2026

(54) SEWING MACHINE

(71) Applicant: JANOME Corporation, Tokyo (JP)

(72) Inventors: Hiroki SHIRATSUCHI, Tokyo (JP); Jotaro SUZUKI, Tokyo (JP)

(73) Assignee: JANOME Corporation, Tokyo (JP)

(21) Appl. No.: 19/373,350

(22) Filed: Oct. 29, 2025

(30) Foreign Application Priority Data
Dec. 5, 2024 (JP) 2024-212084

(51) Int. Cl. G10L 15/22; D05B 19/12; G10L 15/08

(52) U.S. Cl. CPC G10L 15/22; D05B 19/12; G10L 15/08; D05D 2205/02; D05D 2205/12; G10L 2015/088; G10L 2015/221; G10L 2015/223

(57) ABSTRACT

Provided is a sewing machine for forming stitches on cloth by moving a needle up and down. The sewing machine comprises: a microphone that collects a voice uttered by a user; and a control unit configured to process the voice collected by the microphone to thereby recognize a voice instruction uttered by the user to manipulate the sewing machine, and execute the recognized voice instruction. The control unit has a wake word mode and a two-step authentication mode each for executing the voice instruction, on the condition that a predetermined voice is uttered by the user, and a direct instruction mode for executing the voice instruction, without requiring satisfaction of the condition, and wherein the control unit is configured to switch between these voice instruction modes according to at least an operating state of the sewing machine.

### BACKGROUND OF THE INVENTION

### Field of the Invention

The present invention relates to a sewing machine for forming stitches on cloth by moving a needle up and down.

### Description of Related Art

In recent years, various devices have been developed which are capable of recognizing a voice-based instruction (voice instruction) uttered by a user and executing this voice instruction, i.e., performing so-called “voice manipulation.” In the field of sewing machines, there has also been developed a technique for performing various manipulations by voice instructions from a user.

For example, Patent Document 1 (JP H01-13873 B) describes a sewing machine capable of performing voice-based setting and sewing manipulations.

In this Patent Document 1, “motor speed 3”, “feed amount 4”, “straight stitching”, etc., are taken as examples of the voice-based setting manipulation, and “start” is taken as an example of the voice-based sewing manipulation.

### BRIEF SUMMARY OF THE INVENTION

### Technical Problem

In the above voice manipulations performed by voice instructions, improvement in device manipulability can be expected, but, on the other hand, there is concern about the risk of voice instruction misrecognition. For example, if a voice instruction is misrecognized, a manipulation not intended by a user will be performed, and reliability can be compromised in some cases. In this regard, the technique described in Patent Document 1 is configured such that, after voice instruction recognition, the result of the recognition is displayed on an indicator (e.g., “Start” is displayed), and a sewing machine is driven on the condition that a voice indicating the user's approval of the recognition result (e.g., OK) is recognized. Thus, this technique can be said to reduce the risk of voice instruction misrecognition.

The above technique of using a voice instruction in combination with user's approval for execution of the voice instruction will hereinafter be referred to appropriately as “two-step authentication”. This two-step authentication is effective in ensuring reliability, but device manipulability is impaired because it is necessary to additionally obtain user's approval. Thus, applying the two-step authentication to all voice manipulations is considered to be undesirable from a manipulability standpoint.

In view of the above, in the conventional voice manipulations, reliability and manipulability can be said to be in a trade-off relationship. Thus, it would be desirable if voice manipulations satisfying both of reliability and manipulability can be realized.

The present invention has been made to solve the above-mentioned technical problem, and an object thereof is to enable a sewing machine capable of being manipulated by voice instructions to satisfy both of reliability and manipulability in voice manipulations.

### Solution to Problem

In order to achieve the above object, the present invention provides a sewing machine for forming stitches on cloth by moving a needle up and down, the sewing machine comprising: a microphone that collects a voice uttered by a user; and a control unit configured to process the voice collected by the microphone and recognize a voice instruction uttered by the user to manipulate the sewing machine, so as to execute the recognized voice instruction, wherein the control unit has a first mode for executing the voice instruction, on the condition that a predetermined voice is uttered by the user or a predetermined manipulation is performed by the user, and a second mode for executing the voice instruction, without requiring satisfaction of the condition, and wherein the control unit is configured to switch between the first mode and the second mode, according to at least an operating state of the sewing machine.

In the present invention having the above feature, when performing voice manipulations of the sewing machine, a plurality of modes (first and second modes) for recognizing and executing a voice instruction are used, wherein these modes are automatically switched according to an operating state of the sewing machine. In the first mode, the voice instruction is executed on the condition that a predetermined voice is uttered by the user or a predetermined manipulation is performed by the user, so that reliability of the voice manipulations is ensured. On the other hand, in the second mode, the voice instruction is executed, without requiring satisfaction of such a condition (i.e., irrespective of such a condition), so that manipulability in the voice manipulations is ensured. Therefore, in the present invention, the first mode and the second mode are used while being appropriately switched therebetween, which makes it possible to satisfy both of reliability and manipulability in the voice manipulations.

Preferably in the present invention, the predetermined voice is a predetermined wake word other than the voice instruction, the predetermined wake word being uttered by the user before and/or after the recognition of the voice instruction.

The first mode using such a wake word makes it possible to prevent a situation where a voice instruction is executed at a timing not intended by the user, thereby ensuring reliability.

Preferably in the present invention, the sewing machine comprises an instruction notification part to notify the user of the recognized voice instruction, wherein the first mode is a mode for executing the voice instruction, on condition of recognizing that the predetermined voice for giving approval to the content of the notification from the instruction notification part is uttered by the user or the predetermined manipulation for giving approval to the content of the notification from the instruction notification part is performed by the user.

According to the present invention having the above feature, it becomes possible to prevent a situation where a voice instruction is executed at a timing not intended by the user, and a situation where a voice instruction (with content) not intended by the user is executed, thereby effectively ensuring reliability.

Preferably, in the present invention, the control unit is configured to set the second mode when the sewing machine is performing a sewing operation, and to set the first mode when the sewing machine is not performing the sewing operation.

According to the present invention having the above feature, the second mode for executing a manipulation according to the voice instruction is set during a sewing operation in which manipulability is prioritized, so that it becomes possible to reliably ensure manipulability of the sewing machine. In addition, the first mode which requires a predetermined voice or a predetermined manipulation by the user, in addition to the voice instruction, is set during a non-sewing operation in which reliability is prioritized, so that it becomes possible to reliably ensure reliability of the sewing machine.

Preferably, in the present invention, the sewing machine comprises an instruction notification part to notify the user of the recognized voice instruction, wherein the predetermined voice includes a predetermined wake word other than the voice instruction, wherein the first mode includes: a primary first mode for executing the voice instruction, on condition of recognizing, before the recognition of the voice instruction, that the predetermined wake word is uttered by the use; and a secondary first mode for executing the voice instruction, on condition of recognizing, after the recognition of the voice instruction, that the predetermined voice for giving approval to the content of the notification from the instruction notification part is uttered by the user or the predetermined manipulation for giving approval to the content of the notification from the instruction notification part is performed by the user, and wherein the control unit is configured to set the primary first mode when the predetermined wake word is first recognized, and to set the secondary first mode when the voice instruction is first recognized.

According to the present invention having the above feature, it becomes possible to appropriately switch between the primary first mode and the secondary first mode, using, as a starting point, a voice uttered by the user.

Preferably, in the present invention, the sewing machine comprises an instruction notification part to notify the user of the recognized voice instruction, wherein the predetermined voice includes a predetermined wake word other than the voice instruction, wherein the first mode includes: a primary first mode for executing the voice instruction, on condition of recognizing, before and/or after the recognition of the voice instruction, that the predetermined wake word is uttered by the user; and a secondary first mode for executing the voice instruction, on condition of recognizing, after the recognition of the voice instruction, that the predetermined voice for giving approval to the content of the notification from the instruction notification part is uttered by the user or the predetermined manipulation for giving approval to the content of the notification from the instruction notification part is performed by the user, and wherein the control unit is configured to set the primary first mode when the recognized voice instruction is an instruction for setting the sewing machine, and to set the secondary first mode when the recognized voice instruction is an instruction for driving the sewing machine.

In the present invention having the above feature, the first mode is composed of two modes (a primary first mode and a secondary first mode) having different levels of reliability. Specifically, the primary first mode which requires a wake word from the user in addition to the voice instruction is lower in terms of the level of reliability than the secondary first mode which requires user's approval in addition to the voice instruction. In other words, the secondary first mode is higher in terms of the level of reliability than the primary first mode. According to the present invention having such a feature, it becomes possible to adequately set the primary first mode in a situation where the demand for reliability is relatively low, e.g., when setting of the sewing machine is performed, and to adequately set the secondary first mode in a situation where the demand for reliability is relatively high, e.g., when the sewing machine is driven.

Preferably, in the present invention, the sewing machine comprises a timer part to measure a period of time between the recognition of the voice instruction and the recognition of the predetermined voice uttered by the user or the predetermined manipulation performed by the user, before and/or after the recognition of the voice instruction, wherein the control unit is configured to terminate voice recognition processing without executing anything, when the period of time measured by the timer part in the first mode exceeds a predetermined period of time.

According to the present invention having the above feature, it becomes possible to promptly terminate the voice recognition processing when, in the first mode, the predetermined voice or the predetermined manipulation by the user is not recognized even after the measured period of time exceeds the predetermined period of time.

Preferably, in the present invention, the sewing machine comprises a time limit notification part to notify the period of time measured by the timer part, and/or a fact that the period of time measured by the timer part exceeds the predetermined period of time and therefore the voice recognition processing has been terminated.

According to the present invention having the above feature, it becomes possible to allow the user to adequately acknowledge an elapsed time from the first action (voice or manipulation by the user), and/or the fact that the measured period of time exceeds the predetermined period of time and therefore the voice recognition processing has been terminated.

Preferably, in the present invention, the sewing machine further comprises a mode notification part configured to notify the user of mode information, wherein the control unit is configured to control the mode notification part to notify the user of switching between the first mode and the second mode, and/or notify the user of a currently-set one of the first mode and the second mode.

According to the present invention having the above feature, it becomes possible to allow the user to adequately figure out mode switching and/or a current mode.

Preferably, in the present invention, the sewing machine comprises an instruction notification part to notify the user of the recognized voice instruction, wherein the predetermined voice includes a predetermined wake word other than the voice instruction, and wherein the first mode is a mode for executing the voice instruction, on condition of recognizing that the predetermined wake word is uttered by the user, and recognizing that the predetermined voice for giving approval to the content of the notification from the instruction notification part is uttered by the user or the predetermined manipulation for giving approval to the content of the notification from the instruction notification part is performed by the user.

According to the present invention having the first mode configured as above, it becomes possible to more effectively ensure reliability in the voice manipulation.

As above, the present invention makes it possible to enable a sewing machine capable of being manipulated by voice instructions to satisfy both of reliability and manipulability in voice manipulations.

### BRIEF DESCRIPTION OF THE SEVERAL VIEWS OF THE DRAWINGS

FIG. 1 is a perspective view showing the external appearance of a sewing machine according to an embodiment of the present invention.

FIG. 2 is a block diagram showing the electrical configuration of the sewing machine according to the embodiment of the present invention.

FIG. 3 is an explanatory diagram of the flow of voice manipulation in a wake word mode in the embodiment of the present invention.

FIG. 4 is an explanatory diagram of the flow of voice manipulation in a two-step authentication mode in the embodiment of the present invention.

FIG. 5 is an explanatory diagram of the flow of voice manipulation in a direct instruction mode in the embodiment of the present invention.

FIG. 6 is a flowchart showing voice manipulation processing in the embodiment of the invention.

### DETAILED DESCRIPTION OF THE INVENTION

With reference to the accompanying drawings, a sewing machine according to an embodiment of the present invention will be described.

### Apparatus Configuration

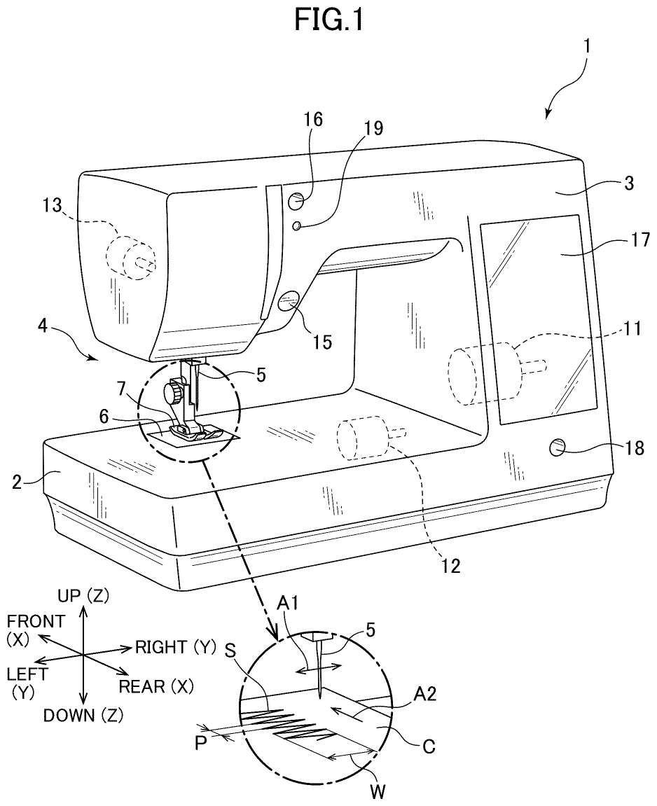

First of all, with reference to FIG. 1, the overall configuration of the sewing machine according to this embodiment will be described. FIG. 1 is a perspective view showing the external appearance of the sewing machine according to this embodiment.

As shown in FIG. 1, the sewing machine 1 mainly comprises: a base part 2 to be placed on a table or the like; an approximately L-shaped arm part 3 extending from the base part 2; and a sewing part 4 provided at one end of the arm part 3. The sewing part 4 has: a needle 5 for forming stitches on cloth; a needle plate 6 covering the periphery of an area into which the needle descends; and a presser 7 for pinching and holding the cloth in cooperation with the needle plate 6. The sewing machine 1 also comprises a drive motor 11, a feed motor 12, and an amplitude motor 13 for performing various operations by the sewing machine 1.

The sewing machine 1 sews cloth by intertwining an upper thread (not shown) and a lower thread (not shown) to form stitches. In this case, the upper thread is provided from a thread spool (not shown) and is inserted into the needle 5, and the lower thread is stored in a bobbin (not shown) while being wound thereon, wherein the bobbin is housed in a bobbin case or shuttle (not shown), and the shuttle is stored inside the sewing machine 1. In the inside of the sewing machine 1, via the action of a drive mechanism (not shown), a torque of the drive motor 14 is converted to an up-down movement of the needle 15, a rotational movement of the shuttle, a reciprocating movement of a cloth-feeding mechanism (not shown), etc.

Specifically, in the sewing machine 1, the needle 5 with the upper thread inserted thereinto is moved to penetrate the cloth and come closer to the bobbin, and then the lower thread and upper thread are intertwined by the action of the shuttle, whereafter the needle 5 is moved to ascend and get out of the cloth, whereby a stitch is formed on the cloth. Then, the cloth-feeding mechanism feeds the cloth by a predetermined amount in a forward direction, and the next stitch is formed in the same process as that described above. In this way, a linear continuous sewing pattern in which stitches are formed at predetermined intervals is applied to the cloth (normal stitching).

Further, as shown in an enlarged view on the underside of FIG. 1, zigzag stitches can be applied to cloth C (which is fed in a direction as indicated by the arrowed line A2) by a combination of the action of a needle swinging mechanism (not shown) for swinging the needle 5 in a right-left direction (double arrowed line A1) and the action of the amplitude motor 13. In this zigzag stitching, a feed pitch P and a zigzag width W are preliminarily set, and the sewing machine 1 can form stitches S as specified by these set values by driving the motors based on the set values.

Further, as shown in FIG. 1, the sewing machine 1 comprises: a manipulation button 15 to be manipulated by a user; a microphone 16 to collect a voice uttered by the user; a display part 17, such as an LCD (Liquid Crystal Display), to display a variety of information; a speaker 18 to output a voice or the like to the user; and a lighting part 19 composed of an LED (Light Emitting Diode). The display part 17 may be composed of a touch panel to enable a touch manipulation by the user. The manipulation button 15 is a manual manipulation part for starting and stopping the sewing machine 1. The lighting part 19 is configured to be switched among light-on, light-off, or blinking, and to change the color of light to be emitted. For example, the lighting part 19 is a microphone indicator. Note that the display part 17, the speaker 18, and the lighting part 19 are equivalent to examples of each of the elements “instruction notification part”, “time limit notification part” and “mode notification” set forth in the appended claims.

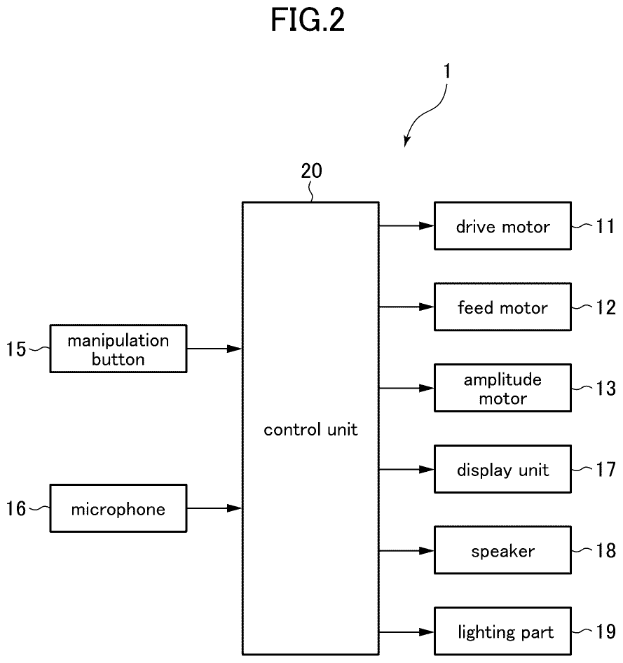

Next, with reference to FIG. 2, the electrical configuration of the sewing machine 1 according to this embodiment will be described. FIG. 2 is a block diagram showing the electrical configuration of the sewing machine 1 according to this embodiment.

As shown in FIG. 2, the sewing machine 1 comprises a control unit 20 to perform various controls in the sewing machine 1. The control unit 20 is composed of a computer comprising: one or more processors (each composed typically of a CPU); and a memory, such as ROM or RAM, that stores therein various programs (including a basic control program such as an OS, and application programs that are run on the OS to realize specific functions) to be interpreted and executed on the one or more processors, and various data.

Specifically, a manipulation signal indicative of manipulation of the manipulation button 15 by the user and a voice signal corresponding to a voice collected by the microphone 16 are input to the control unit 20. In a case where the display part 17 is composed of a touch panel, a manipulation signal corresponding to touch manipulation by the user is also input to the control unit 20. Then, the control unit 20 outputs control signals, based on these signals input thereto, to the drive motor 11, the feed motor 12, the amplitude motor 13, the display part 17, the speaker 18, and the lighting part 19, to control them. The details of the control to be performed by the control unit 20 in this embodiment will be described below.

### Control in this Embodiment

Next, the control to be performed by the control unit 20 in this embodiment will be specifically described.

In this embodiment, the control unit 20 processes the voice signal corresponding to the voice collected by the microphone 16 to thereby recognize a voice instruction uttered by the user to manipulate the sewing machine 1, and executes the recognized voice instruction (voice manipulation). In particular, in this embodiment, the control unit 20 has a plurality of modes for recognizing and executing a voice instruction in performing the voice manipulation (each of these modes will hereinafter be referred to as “voice instruction mode” as appropriate), wherein the control unit 20 automatically switches between the plurality of voice instruction modes, according to an operating state of the sewing machine 1, etc. This is intended to satisfy both of reliability and manipulability in the voice manipulation.

Specifically, the control unit 20 has the following three modes, as the above-mentioned voice instruction modes:
(i) a wake word mode for executing the voice instruction on condition of recognizing that a predetermined wake word is uttered by the user, before the recognition of the voice instruction;
(ii) a two-step authentication mode for executing the voice instruction on condition of recognizing, after the recognition of the voice instruction, that a predetermined voice for giving approval to execution of the voice instruction is uttered by the user; and
(iii) a direct instruction mode for executing the voice instruction immediately after the recognition of the voice instruction, without requiring satisfaction of the above-mentioned conditions.

More specifically, in the wake word mode, on the condition that the user utters a wake word, a voice instruction recognized after the utterance of the wake word is executed, thereby preventing a situation where a voice instruction is executed at a timing not intended by the user. The wake word is a preliminarily-set arbitrary word (which is equivalent to a password-like keyword), and includes a word for calling out, such as “Hello”, “Hi” or “Hey”, and a nickname for the apparatus.

On the other hand, in the two-step authentication mode, the recognized voice instruction is notified to the user, and is executed on the condition that the user gives approval to the content of the notification, thereby preventing a situation where a voice instruction is executed at a timing not intended by the user, and a situation where a voice instruction (with content) not intended by the user is executed. In the two-step authentication mode, the user utters a voice such as “OK”, “Yes” or “GO” to thereby give approval to the execution of the voice instruction.

In this embodiment, the control unit 20 sets the direct instruction mode when the sewing machine 1 is performing a sewing operation (i.e., when the needle 5 is being driven up and down by the drive motor 11), so as to prioritize manipulability of the sewing machine 1. In contrast, when the sewing machine 1 is not performing the sewing operation, the control unit 20 sets the wake word mode or the two-step authentication mode so as to prioritize reliability of the sewing machine 1. Further, in the situation where the sewing machine 1 is not performing the sewing operation, the control unit 20 sets the wake word mode when a wake word is first recognized, and sets the two-step authentication mode when a voice instruction is first recognized.

Note that each of the wake word mode and the two-step authentication mode is equivalent to “first mode” set forth in the appended claims, and the direct instruction mode is equivalent to the “second mode” set forth in the appended claims. Further, the wake word mode and the two-step authentication mode are equivalent, respectively, to “primary first mode” and “secondary first mode” set forth in the appended claims.

(Flow of Voice Manipulation in each Mode)

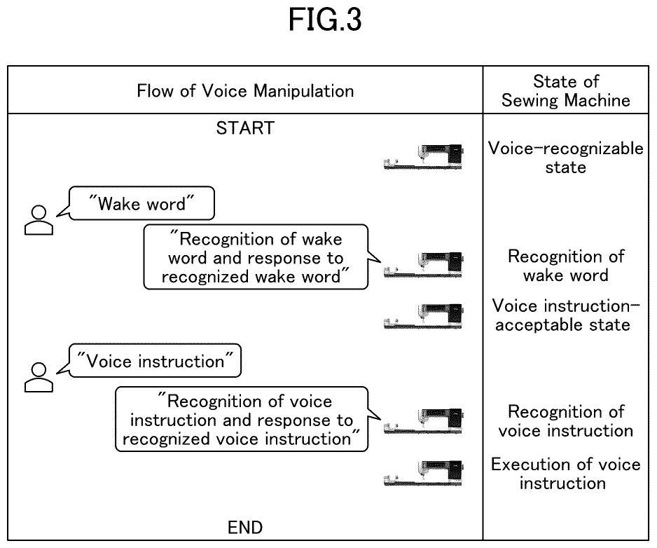

Next, with reference to FIGS. 3 to 5, the flow of voice manipulation in each voice instruction mode in this embodiment will be specifically described.

FIG. 3 is an explanatory diagram the flow of voice manipulation in the wake word mode in this embodiment. First, in the wake word mode, when the user utters a predetermined wake word in a situation where the sewing machine 1 is in a voice-recognizable state, the control unit 20 of the sewing machine 1 processes a voice collected by the microphone 16 to recognize the wake word. At this time, in order to respond to the recognized wake word, the control unit 20 performs control of, e.g., changing the color of the lighting part 19 (e.g., from red to green), or displaying the text “Wake word has been accepted” on the display part 17, or outputting a response voice (such as “OK” or “Yes”) from the speaker 18, or outputting a beep sound from the speaker 18.

Then, when the sewing machine 1 enters a state of accepting a voice instruction from the user, and when the user utters a voice instruction within a predetermined acceptance period of time, the control unit 20 processes a voice signal corresponding to a voice collected by the microphone 16 to recognize the voice instruction. At this time, in order to respond to the recognized voice instruction, the control unit 20 operates to display the content corresponding to this voice instruction on the display part 17, and/or output a voice corresponding to the content of the voice instruction, from the speaker 18. Subsequently, the control unit 20 executes the recognized voice instruction. On the other hand, when the user does not utter any voice instruction within the predetermined acceptance period of time, the control unit 20 terminates voice recognition processing without executing anything. Note that the control unit 20 functions as “timer part” set forth in the appended claims.

Here, the wake word mode is typically used to perform various settings (setting changes) within the sewing machine 1 by voice instructions, wherein such settings do not involve any movement of the sewing machine 1. In this case, when responding to a recognized voice instruction, the control unit 20 operates to display the text “Settings have been changed” on the display party 17, and/or output a voice corresponding to this text from the speaker 18, for example. In one example, the wake word mode is used to set the feed pitch P and the zigzag width W which are applied in zigzag stitching (see FIG. 1). In other examples, the wake word mode is used when switching between a normal mode for performing normal stitching and an embroidery mode for performing embroidery stitching (in this mode, an embroidery unit comprising an embroidery frame will be attached to the sewing machine 1), or when calling up or selecting various patterns or designs for use in the embroidery mode.

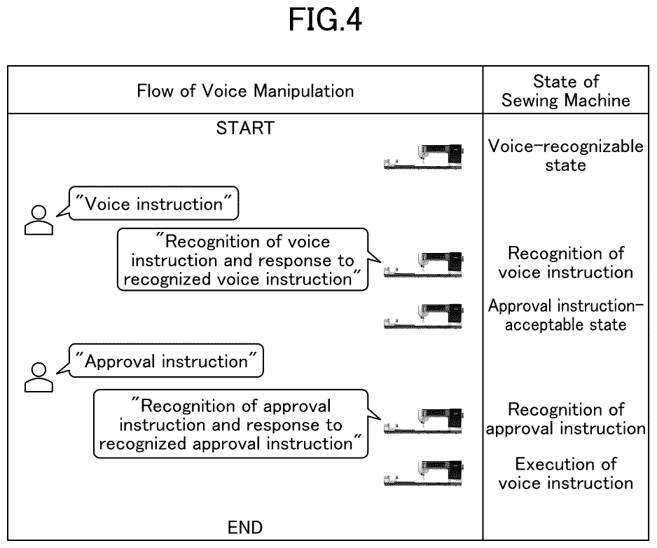

Next, FIG. 4 is an explanatory diagram of the flow of voice manipulation in the two-step authentication mode in this embodiment. First, in the two-step authentication mode, when the user utters a voice instruction in the situation where the sewing machine 1 is in the voice-recognizable state, the control unit 20 of the sewing machine 1 processes a voice signal corresponding to a voice collected by the microphone 16 to recognize the voice instruction. At this time, in order to respond to the recognized voice instruction, the control unit 20 operates to display the content of this voice instruction on the display part 17 and/or output a voice corresponding to the content of the voice instruction, from the speaker 18.

Then, the sewing machine 1 enters a state of accepting an approval instruction from the user, and when the user utters the approval instruction (such as “OK”, “Yes” or “GO”) within a predetermined acceptance period of time, the control unit 20 processes a sound signal corresponding to a voice collected by the microphone 16 to recognize the approval instruction. At this time, in order to respond to the recognized approval instruction, the control unit 20 performs control of, e.g., changing the color of the lighting part 19 (e.g., from red to green), or displaying the text “Approval has been accepted” on the display part 17, or outputting a response voice (such as “OK” or “Yes”) from the speaker 18, or outputting a beep sound from the speaker 18. Subsequently, the control unit 20 executes the previously recognized voice instruction. On the other hand, when the user does not utter any approval instruction within the predetermined acceptance period of time, the control unit 20 terminates the voice recognition process without executing anything.

Here, the two-step authentication mode is typically used to move (operate) the sewing machine 1 by voice instructions. In this case, when responding to a recognized voice instruction, the control unit 20 operates to display the text “Operation will be started” on the display part 17, and/or output a voice corresponding this text from the speaker 18, for example. In one example, the two-step authentication mode is used to start the sewing machine 1 or to move the embroidery frame of the embroidery unit to an embroidery area or a home position.

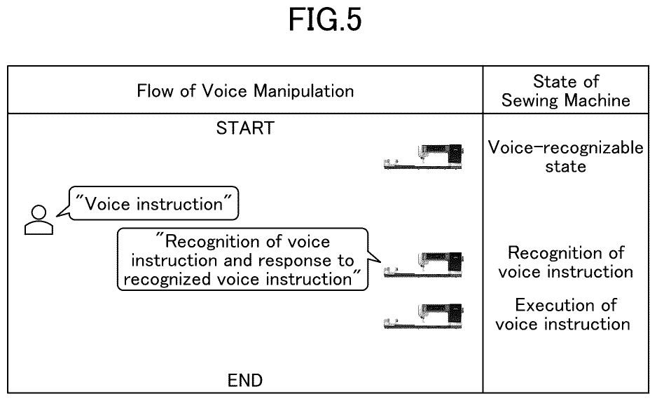

Next, FIG. 5 is an explanatory diagram of the flow of voice manipulation in the direct instruction mode in this embodiment. First, in the direct instruction mode, when the user utters a voice instruction in the situation where the sewing machine 1 is in the voice-recognizable state, the control unit 20 of the sewing machine 1 processes a voice signal corresponding to a voice collected by the microphone 16 to recognize the voice instruction. At this time, in order to respond to the recognized voice instruction, the control unit 20 operates to display the content of this voice instruction on the display part 17, and/or output a voice corresponding to the voice instruction, from the speaker 18. Then, the control unit 20 immediately executes the recognized voice instruction.

Here, the direct instruction mode is used to, e.g., stop the sewing machine 1, or to change a stitching direction of the sewing machine 1 (e.g., change the stitching direction backward in order to perform backstitching), or to change an operating speed of the sewing machine 1.

In the above embodiment, the sewing machine 1 is configured to respond to the recognized wake word, the recognized voice instruction or the recognized approval instruction (response-to-recognition), but such a response-to-recognition may be omitted as appropriate. However, it is necessary to perform a response-to-recognition with respect to the voice instruction in the two-step authentication mode (e.g., text display or voice output of “Operation will be started” or the like), because in the two-step authentication mode, a response-to-recognition to notify the user of the recognized voice instruction is required to obtain user's approval for execution of this voice instruction.

### (Flowchart)

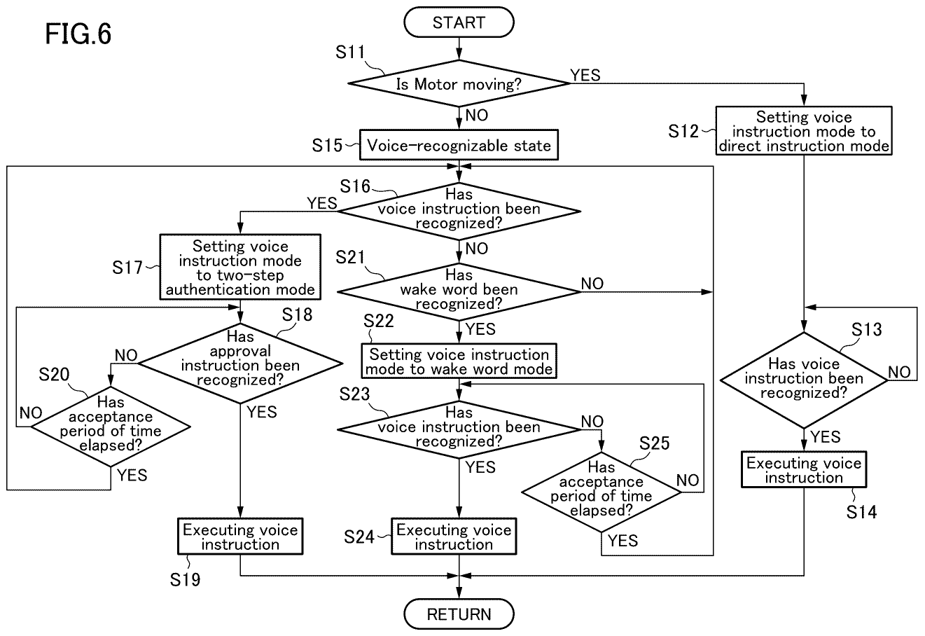

Next, with reference to FIG. 6, a flowchart showing the voice manipulation processing in this embodiment will be described. This flow is repeatedly executed by the control unit 20 of the sewing machine 1 in a predetermined cycle. For details, the one or more processors in the control unit 20 read out a program stored in the memory and executes the program, whereby processing and control pertaining to this flow are realized.

First, in step S11, the control unit 20 determines whether or not the drive motor 11 is moving. Here, the control unit 20 determines whether or not the needle 5 is being driven up and down by the drive motor 11, i.e., whether or not the sewing machine 1 is performing the sewing operation.

As a result of step S11, when the control unit 20 determines that the drive motor 11 is moving (step S11: Yes), i.e., the sewing machine 1 is performing the sewing operation, it proceeds to step S12. In step S12, the control unit 20 sets the voice instruction mode to the direct instruction mode, and enters a voice-recognizable state (standby state) in which it accepts a voice signal from the microphone 16. In this case, the control unit 20 may notify the user of a fact that the voice instruction mode has been switched to the direct instruction mode and/or a currently-set one of the voice instruction modes is the direct instruction mode, by means of color of the lighting part 19, display of a text on the display part 17, or a sound output from the speaker 18.

Then, the control unit 20 proceeds to step S13 to determine whether a voice instruction from the user has been recognized, based on a voice signal corresponding to a voice collected by the microphone 16. As a result, when the control unit 20 determines that a voice instruction has been recognized (step S13: Yes), it proceeds to step S14 to execute this voice instruction. In contrast, when the control unit 20 does not determine that a voice instruction has been recognized (step S13: No), it returns to step S13. In this case, the control unit 20 repeats the determination of step S13 until the voice instruction is recognized.

On the other hand, when, in step S11, the control unit 20 does not determine that the drive motor 11 is moving (step S11: No), i.e., the sewing machine 1 is not performing the sewing operation, it proceeds to step S15. In step S15, the control unit 20 enters the voice-recognizable state (standby state) in which it accepts a voice signal from the microphone 16. Then, the control unit 20 proceeds to step S16 to determine whether or not a voice instruction from the user has been recognized, based on a voice signal corresponding to a voice collected by the microphone 16.

As a result of step S16, when the control unit 20 determines that a voice instruction has been recognized (step S16: Yes), it proceeds to step S17. In step S17, the control unit 20 sets the voice instruction mode to the two-step authentication mode. In this case, responding to the recognized voice instruction, the control unit 20 operates to display the content of the voice instruction on the display part 17, and/or output a voice corresponding to the content of the voice instruction from the speaker 18, in order to obtain user's approval for execution of this voice instruction. Further, the control unit 20 may notify the user of a fact that the voice instruction mode has been switched to the two-step authentication mode and/or a currently-set one of the voice instruction modes is the two-step authentication mode, by means of color of the lighting part 19, display of a text on the display part 17, or a sound output from the speaker 18.

Then, the control unit 20 proceeds to step S18 to determine, based on a sound signal corresponding to a sound collected by the microphone 16, whether or not an approval instruction from the user has been recognized. As a result, when the control unit 20 determines that the approval instruction has been recognized (step S18: Yes), it proceeds to step S19 to execute the voice instruction recognized in step S16.

In contrast, when the control unit 20 does not determine that an approval instruction has been recognized (step S18: No), it proceeds to step S20 to determine whether or not a predetermined acceptance period of time has elapsed since the voice instruction is recognized in step S16. As a result, when the control unit 20 determines that the acceptance period of time has elapsed (step S20: Yes), it returns to step S16 to recognize a voice instruction or wake word again. In contrast, when the control unit 20 does not determine that the acceptance period of time has elapsed (step S20: No), it returns to step S18 to wait for an event that an approval instruction from the user is recognized.

The control unit 20 may notify the user of an elapse of time until it reaches the above-mentioned acceptance period of time, i.e., an elapsed period of time since a voice instruction is recognized in step S16. In one example, the control unit 20 operates to display a numerical countdown on the display part 17. In another example, the control unit 20 operates to: blink the lighting part 19 during the elapse of time until it reaches the acceptance period of time; gradually increase the period of this blinking over time; and when it has reached the acceptance period of time, switch the lighting part 19 from blinking to light-on or light-off. Further, instead of or in addition to notifying the user of the elapsed time since a voice instruction is recognized, the control unit 20 may notify the user of a fact that the elapsed period of time has exceeded the acceptance period of time, and the voice recognition processing has been terminated.

On the other hand, in step S16, when the control unit 20 does not determine that a voice instruction has been recognized (step S16: No), it proceeds to step S21. In step S21, the control unit 20 determines whether or not a wake word from the user has been recognized, based on a voice signal corresponding to a voice collected by the microphone 16. As a result, when the control unit 20 does not determine that a wake word has been recognized (step S21: No), it returns to step S16. In this case, the control unit 20 repeats the determinations of steps S16 and S21 until a voice instruction or a wake word is recognized.

In contrast, if the control unit 20 determines that a wake word has been recognized (step S21: Yes), it proceeds to step S22. In step S22, the control unit 20 sets the voice instruction mode to the wake word mode. In this case, the control unit 20 notifies the user of a fact that the voice instruction mode has been switched to the wake word mode and/or a currently-set one of the voice instruction modes is the wake word mode, by means of color of the lighting part 19, display of a text on the display part 17, or a sound output from the speaker 18.

Then, the control unit 20 proceeds to step S23 to determine whether or not a voice command from the user has been recognized, based on a voice signal corresponding to a sound collected by the microphone 16. As a result, when the control unit 20 determines that a voice command has been recognized (step S23: Yes), it proceeds to step S24 to execute this voice command.

In contrast, when the control unit 20 does not determine that a voice instruction has been recognized (step S23: No), it proceeds to step S25 to determine whether a predetermined acceptance period of time has elapsed since a wake word is recognized in step S21. As a result, when the control unit 20 determines that the acceptance period of time has elapsed (step S25: Yes), it returns to step S16 to recognize a voice instruction or a wake word again. On the other hand, when the control unit 20 does not determine that the acceptance period of time has elapsed (step S25: No), it returns to step S23 to wait for an event that a voice instruction from the user is recognized.

The control unit 20 may notify the user of an elapse of time until it reaches the above-mentioned acceptance period of time, i.e., an elapsed period of time since a wake word is recognized in step S21. In one example, the control unit 20 operates to display a numerical countdown on the display part 17. In another example, the control unit 20 operates to: blink the lighting part 19 during the elapse of time until it reaches the acceptance period of time; gradually increase the period of this blinking over time; and when it has reached the acceptance period of time, switch the lighting part 19 from blinking to light-on or light-off. Further, instead of or in addition to notifying the user of the elapsed time since a wake word is recognized, the control unit 20 may notify the user of a fact that the elapsed period of time has exceeded the acceptance period of time, and the voice recognition processing has been terminated.

### Functions and Effects

Next, functions and effects of the sewing machine 1 according to the above embodiment will be described.

A sewing machine 1 according to the above embodiment is designed to form stitches on cloth by moving a needle 5 up and down. The sewing machine comprises: a microphone 16 that collects a voice uttered by a user; and a control unit configured to process the voice collected by the microphone 16 to thereby recognize a voice instruction uttered by the user to manipulate the sewing machine, and execute the recognized voice instruction, wherein the control unit has a wake word mode and a two-step authentication mode each for executing the voice instruction, on the condition that a predetermined voice is uttered by the user, and a direct instruction mode for executing the voice instruction, without requiring satisfaction of the condition, and wherein the control unit is configured to switch between such voice instruction modes, according to at least an operating state of the sewing machine 1.

In the above embodiment, when performing voice manipulations, a plurality of modes for recognizing a voice instruction and executing the recognized voice instruction are used, wherein the plurality of modes are automatically switched according to an operating state of the sewing machine 1. Particularly in the above embodiment, as the plurality of modes, a direct instruction mode capable of ensuring manipulability and a wake word mode and a two-step authentication mode each capable of ensuring reliability are used as the plurality of modes. Thus. the above embodiment makes it possible to satisfy both of reliability and manipulability in the voice manipulations.

In the above embodiment, the predetermined voice is a predetermined wake word other than the voice instruction, wherein the predetermined wake word is uttered by the user before the recognition of the voice instruction. That is, the control unit 20 uses the wake word mode for executing a recognized voice instruction when it recognizes that a predetermined wake word is uttered by the user. This makes it possible to prevent a situation where a voice instruction is executed at a timing not intended by the user, thereby ensuring reliability.

In the above embodiment, the sewing machine 1 comprises a display part 17, a speaker 18, and a lighting part each for notifying the user of the recognized voice instruction, wherein the two-step authentication mode is a mode for executing the recognized voice instruction, on condition of recognizing that a predetermined voice for giving approval to the content of this notification is uttered by the user. Such a two-step authentication mode makes it possible to prevent a situation where a voice instruction is executed at a timing not intended by the user, and a situation where a voice instruction (with content) not intended by the user is executed, thereby effectively ensuring reliability.

In the above embodiment, the control unit 20 is configured to set the direct instruction mode when the sewing machine 1 is performing a sewing operation, and to set the wake word mode or the two-step authentication mode when the sewing machine 1 is not performing the sewing operation. In this way, the direct instruction mode for promptly executing a recognized voice instruction is set during a sewing operation in which manipulability is prioritized, so that it becomes possible to reliably ensure manipulability of the sewing machine 2. In addition, the wake word mode or the two-step authentication mode which requires a wake word or approval in addition to the voice instruction is set during a non-sewing operation in which reliability is prioritized, so that it becomes possible to reliably ensure reliability of the sewing machine 2.

In the above embodiment, the control unit 20 is configured to set the wake word mode when a wake word is first recognized, and to set the two-step authentication mode when the voice instruction is first recognized. This makes it possible to appropriately switch between the wake word mode and the two-step authentication mode, using, as a starting point, a voice uttered by the user.

In the above embodiment, the control unit 20 is configured to measure a period of time between the recognition of a wake word uttered by the user and the recognition of a subsequent voice instruction or a period of time between the recognition of a voice instruction and the recognition of a subsequent voice for approval by the user, and when the measured period of time exceeds an acceptance period of time, terminate voice recognition processing without executing anything. This makes it possible to promptly terminate the voice recognition processing in the wake word mode and the two-step authentication mode, when the predetermined voice is not recognized even after the measured period of time exceeds the acceptance period of time. Further, in the above embodiment, the display part 17, the speaker 18, and the lighting part 19 are configured to notify the user of the period of time measured in the above manner, and/or the fact that the measured period of time exceeds the acceptance period of time and therefore the voice recognition processing has been terminated. This makes it possible to allow the user to adequately acknowledge an elapsed time from the first voice uttered by the user, and/or the fact that the measured period of time exceeds the acceptance period of time and therefore the voice recognition processing has been terminated.

In the above embodiment, the control unit is configured to control the display part 17, the speaker 18, and the lighting part 19 to notify the user of switching between the voice instruction modes and/or notify the user of a currently-set one of the voice instruction modes. This makes it possible to allow the user to adequately figure out switching between the voice instruction modes and/or a currently-selected mode of the voice instruction modes.

### Modifications

Next, modifications of the above embodiment will be described. It should be noted that the following modifications can be implemented in combination with each other as appropriate.

### (Modification 1)

In the above embodiment, the wake word mode is configured to execute a voice instruction when a wake word is recognized before the recognition of the voice instruction, i.e., when the voice instruction is recognized after the recognition of the wake word. In another embodiment, the wake word mode may be configured to execute a voice instruction when a wake word is recognized after the recognition of the voice instruction, i.e., when the voice instruction is recognized before the recognition of the wake word. In still another embodiment, the wake word mode may be configured to execute a manipulation according to a voice instruction when a wake word is recognized both before and after the recognition of the voice instruction.

### (Modification 2)

In the above embodiment, the two-step authentication mode is configured to execute a manipulation according to a voice instruction when it is recognized that a predetermined voice for giving approval to the execution of the manipulation according to the voice instruction is uttered by the user. In another embodiment, the two-step authentication mode may be configured to execute a manipulation according to a voice instruction when it is recognized that a predetermined manipulation (e.g., touch panel manipulation or hand gesture manipulation) for giving approval to the execution of the manipulation according to the voice instruction is performed by the user.

### (Modification 3)

In the above embodiment, the control unit 20 is configured to set the wake word mode when a wake word is recognized before the recognition of a voice instruction, and set the two-step authentication mode when a voice instruction is recognized before the recognition of a wake word. In the above embodiment, the control unit 20 is configured to switch between the wake word mode and the two-step authentication mode, using, as a starting point, a voice uttered by the user. In another embodiment, the control unit 20 may be configured to set the wake word mode when a voice instruction for setting of the sewing machine 1 is recognized and set the two-step authentication mode when a voice instruction for driving the sewing machine 1 is recognized.

Here, the wake word mode, which requires a wake word from the user in addition to a voice instruction, can be said to be lower in terms of the level of reliability than the two-step authentication mode, which requires approval from the user in addition to a voice instruction. In other words, the two-step authentication mode can be said to be higher in terms of the level of reliability than the wake word mode. Thus, the above-mentioned another embodiment makes it possible to adequately set the wake word mode in a situation where demand for reliability is relatively low, such as when setting of the sewing machine 1 is being performed, and to adequately set the two-step authentication mode in a situation where demand for reliability is relatively high, such as when the sewing machine 1 is driven.

### (Modification 4)

In the above embodiment, the wake word mode and the two-step authentication mode are used as “first mode” set forth in the appended claims. In another embodiment, the first mode may be composed of a mode obtained by combining the wake word mode and the two-step authentication mode. Specifically, the first mode may be composed of a mode for executing a voice instruction, on condition of recognizing that a predetermined wake word is uttered by the user and that a predetermined voice for giving approval to the content of a notification responding to the voice instruction is uttered by the user (or a predetermined manipulation for giving approval to the content of a notification responding to the voice instruction is performed by the user). For example, in such a mode, when a wake word, a voice instruction, and an approval instruction are recognized in this order, the control unit 20 executes the voice instruction, or when a voice instruction, an approval instruction, and a wake word are recognized in this order, the control unit 20 executes the voice instruction. Such another embodiment makes it possible to more effectively ensure reliability in voice manipulations.

### (Modification 5)

In the above embodiment, the microphone 16, display part 17, speaker 18, lighting part 19, and control unit 20 are provided in a machine body of the sewing machine. In another embodiment, some or all of them (microphone 16, display part 17, speaker 18, lighting part 19 and control unit 20) may be separate from a sewing machine. Specifically, a voice-manipulatable sewing machine comprising a smartphone, a tablet or a smart speaker capable of wired or wireless communication with the sewing machine, where the sewing machine may have a configuration in which: a microphone of the smartphone or the like is used as the microphone 16; a speaker of the smartphone or the like is used as the speaker 18; a screen of the smartphone or the like is used as the display part 17 and the lighting part 19; and a control device of the smartphone or the like is used as at least part of the control unit 20 (mainly as a voice recognition executing part, etc.). For example, in this embodiment, an existing smartphone, tablet, or smart speaker can be used, so that the microphone, the speaker, the display part, etc., are no longer necessary as components of the main body of the sewing machine, which makes it possible to provide a voice-manipulatable sewing machine with a simplified and low-cost structure.

What is claimed is:

1. A sewing machine for forming stitches on cloth by moving a needle up and down, the sewing machine comprising:
a microphone that collects a voice uttered by a user; and
a control unit configured to process the voice collected by the microphone and recognize a voice instruction uttered by the user to manipulate the sewing machine, so as to execute the recognized voice instruction,
wherein the control unit has a first mode for executing the voice instruction, on the condition that a predetermined voice is uttered by the user or a predetermined manipulation is performed by the user, and a second mode for executing the voice instruction, without requiring satisfaction of the condition, and
wherein the control unit is configured to switch between the first mode and the second mode, according to at least an operating state of the sewing machine.

2. The sewing machine according to claim 1, wherein the predetermined voice is a predetermined wake word other than the voice instruction, the predetermined wake word being uttered by the user before and/or after the recognition of the voice instruction.

3. The sewing machine according to claim 1, comprising an instruction notification part to notify the user of the recognized voice instruction, wherein the first mode is a mode for executing the voice instruction, on condition of recognizing that the predetermined voice for giving approval to the content of the notification from the instruction notification part is uttered by the user or the predetermined manipulation for giving approval to the content of the notification from the instruction notification part is performed by the user.

4. The sewing machine according to claim 1, wherein the control unit is configured to set the second mode when the sewing machine is performing a sewing operation, and to set the first mode when the sewing machine is not performing the sewing operation.

5. The sewing machine according to claim 1, comprising an instruction notification part to notify the user of the recognized voice instruction,
wherein the predetermined voice includes a predetermined wake word other than the voice instruction,
wherein the first mode includes: a primary first mode for executing the voice instruction, on condition of recognizing, before the recognition of the voice instruction, that the predetermined wake word is uttered by the use; and a secondary first mode for executing the voice instruction, on condition of recognizing, after the recognition of the voice instruction, that the predetermined voice for giving approval to the content of the notification from the instruction notification part is uttered by the user or the predetermined manipulation for giving approval to the content of the notification from the instruction notification part is performed by the user, and
wherein the control unit is configured to set the primary first mode when the predetermined wake word is first recognized, and to set the secondary first mode when the voice instruction is first recognized.

6. The sewing machine according to claim 1, comprising an instruction notification part to notify the user of the recognized voice instruction,
wherein the predetermined voice includes a predetermined wake word other than the voice instruction,
wherein the first mode includes: a primary first mode for executing the voice instruction, on condition of recognizing, before and/or after the recognition of the voice instruction, that the predetermined wake word is uttered by the user; and a secondary first mode for executing the voice instruction, on condition of recognizing, after the recognition of the voice instruction, that the predetermined voice for giving approval to the content of the notification from the instruction notification part is uttered by the user or the predetermined manipulation for giving approval to the content of the notification from the instruction notification part is performed by the user, and
wherein the control unit is configured to set the primary first mode when the recognized voice instruction is an instruction for setting the sewing machine, and to set the secondary first mode when the recognized voice instruction is an instruction for driving the sewing machine.

7. The sewing machine according to claim 1, comprising a timer part to measure a period of time between the recognition of the voice instruction and the recognition of the predetermined voice uttered by the user or the predetermined manipulation performed by the user, before and/or after the recognition of the voice instruction, wherein the control unit is configured to terminate voice recognition processing without executing anything, when the period of time measured by the timer part in the first mode exceeds a predetermined period of time.

8. The sewing machine according to claim 7, comprising a time limit notification part to notify the period of time measured by the timer part, and/or a fact that the period of time measured by the timer part exceeds the predetermined period of time and therefore the voice recognition processing has been terminated.

9. The sewing machine according to claim 1, further comprising a mode notification part configured to notify the user of mode information, wherein the control unit is configured to control the mode notification part to notify the user of switching between the first mode and the second mode, and/or notify the user of a currently-set one of the first mode and the second mode.

10. The sewing machine according to claim 1, comprising an instruction notification part to notify the user of the recognized voice instruction,
wherein the predetermined voice includes a predetermined wake word other than the voice instruction, and
wherein the first mode is a mode for executing the voice instruction, on condition of recognizing that the predetermined wake word is uttered by the user, and recognizing that the predetermined voice for giving approval to the content of the notification from the instruction notification part is uttered by the user or the predetermined manipulation for giving approval to the content of the notification from the instruction notification part is performed by the user.
